(19) United States
(12) Patent Application Publication
(10) Pub. No.: US 2002/0085279 A1
(43) Pub. Date: Jul. 4, 2002

(54) Projection screen

(75) Inventors: Fu-Ming Chuang, Hsin-Chu Hsien (TW); Sheng-Hsiung Chan, Hsin-Chu Hsien (TW); Han-Wen Tsai, Hsin-Chu Hsien (TW)

Correspondence Address: MERCHANT & GOULD, 3200 IDS Center, 80 South 8th Street, Minneapolis, MN, 55402-2215, US

(73) Assignee: PROKIA TECHNOLOGY CO., LTD.

(21) Appl. No.: 09/751,425

(22) Filed: Dec. 29, 2000

(51) Int. Cl. G03B 21/56

(52) U.S. Cl. 359/460; 359/449

(57) ABSTRACT

A projection screen includes a lens base having a front side, a rear side, and an array of bores that extend from the rear side to the front side. Each of the bores tapers in a direction from the rear side to the front side. The front side is formed with a plurality of windows, each of which is aligned and communicated with a respective one of the bores. Light that enters the bores from the rear side of the lens base is subjected to multiple total internal reflections as the light propagates along the bores prior to exiting the lens base at the windows.

### BACKGROUND OF THE INVENTION

1. Field of the Invention

The invention relates to a projection screen, more particularly to a projection screen which can be used to show high quality images that are not adversely influenced by ambient light and which is relatively easy and less costly to manufacture.

2. Description of the Related Art

A display apparatus incorporates a projection screen for showing images thereon. The image quality is generally influenced by the structure of the projection screen. Properties that are commonly used to define the quality of an image shown on a projection screen include contrast, brightness, color, and resolution. Contrast is the difference in brightness between the lightest and darkest areas in an image. When the contrast is large, details of the image can be seen more clearly. The projection screenplays an important role in determining the contrast characteristics of a display apparatus.

Referring to FIG. 1, a conventional back-projection screen 1 is shown to comprise a Fresnel lens 11, a lenticular lens 12 and a diffuser 13. The Fresnel lens 11 is usually disposed in front of a light source and optical components of a display apparatus, and has a rear surface formed with stepped setbacks and a rounded center so as to possess the optical properties of a much thicker lens. The Fresnel lens 11 enables light rays to be radiated directly toward the viewer. The lenticular lens 12 is disposed immediately in front of the Fresnel lens 11, and has a rear surface formed with convex protrusions for refracting light rays, thereby controlling the angle of unidirectional light divergence, and thus the light-viewing angle. The diffuser 13 is disposed immediately in front of the lenticular lens 12 and is made of a semi-transparent material. The diffuser 13 diverges straight light rays to attain a large light-viewing angle.

As such, light impinging upon the rear side of the screen 1 is refracted by the Fresnel lens 11 in order to obtain forwardly extending parallel light rays. After passing through the Fresnel lens 11, the light rays are subsequently refracted by the lenticular lens 12 so as to obtain forwardly diverging light rays, which are further scattered by the diffuser 13 to achieve an optimum light-viewing angle.

Some of the drawbacks of the aforesaid conventional back-projection screen 1 are as follows:

1. The light rays are subjected to multiple refraction and reflection and travel different paths while passing through the three layers of the projection screen 1. During the scattering phase of the light rays, the light rays will interfere with each other, thereby resulting in a speckle effect and in a moire effect that degrade the quality of the image viewed on the projection screen

1. Particularly, the speckle effect will give a granular appearance to the image on the projection screen 1, whereas the moiré effect will result in a new set of periodic patterns at intersections of two or more original sets of periodic patterns of the image.

2. In the conventional projection screen 1, light intensity is brightest at the central portion, and is gradually diminished in directions toward the outer periphery of the projection screen 1. This phenomenon arises due to the fact that, because the light rays that reach the outer periphery of the projection screen 1 are inclined, the effective intensity of the light rays thereat is accordingly smaller. This phenomenon, which is characterized by the cosine θ attenuation of the light intensity distribution, results in an image with uneven brightness throughout the conventional projection screen 1.

3. Ambient light that is incident on the front side of the conventional projection screen 1 will be reflected and will adversely affect the contrast of the image shown thereon. In other words, the contrast of the image viewed on the conventional projection screen 1 is adversely influenced by ambient light conditions.

4. The conventional projection screen 1 includes three layers having different characteristics and configurations. In addition, the interfaces among the three layers must be carefully designed to ensure a particular path for the light rays that pass through the projection screen 1. The conventional projection screen 1 is thus difficult and expensive to manufacture.

### SUMMARY OF THE INVENTION

Therefore, the object of the present invention is to provide a projection screen which can be used to show high quality images that are not adversely influenced by ambient light and which is relatively easy and less costly to manufacture.

Accordingly, the projection screen of this invention comprises:

a lens base having a front side, a rear side, and an array of bores that extend from the rear side to the front side, each of the bores tapering in a direction from the rear side to the front side, the front side being formed with a plurality of windows, each of which is aligned and communicated with a respective one of the bores; and

reflecting means, disposed in the bores, for subjecting light that enters the bores from the rear side of the lens base to multiple total internal reflections as the light propagates along the bores prior to exiting the lens base at the windows.

Preferably, the lens base is configured so as to be capable of absorbing ambient light at the front side thereof for enhancing contrast.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional back-projection screen;

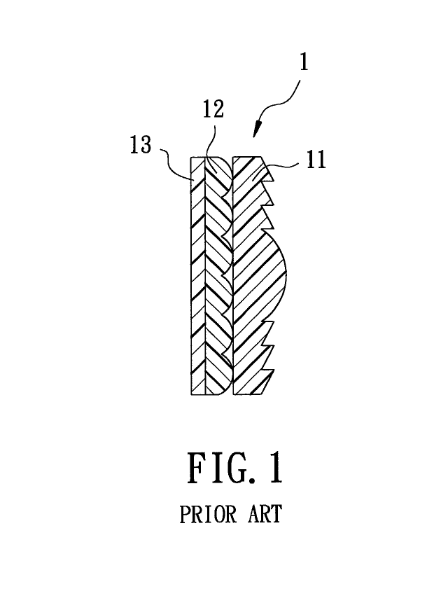

FIG. 2 is a fragmentary exploded perspective view of the first preferred embodiment of a projection screen according to this invention;

FIG. 3 is a schematic fragmentary sectional view of the first preferred embodiment;

FIG. 4 is a schematic fragmentary sectional view of the second preferred embodiment of a projection screen according to this invention; and

FIG. 5 is a schematic fragmentary sectional view of the third preferred embodiment of a projection screen according to this invention.

### DETAILED DESCRIPTION OF THE PREFERRED EMBODIMENTS

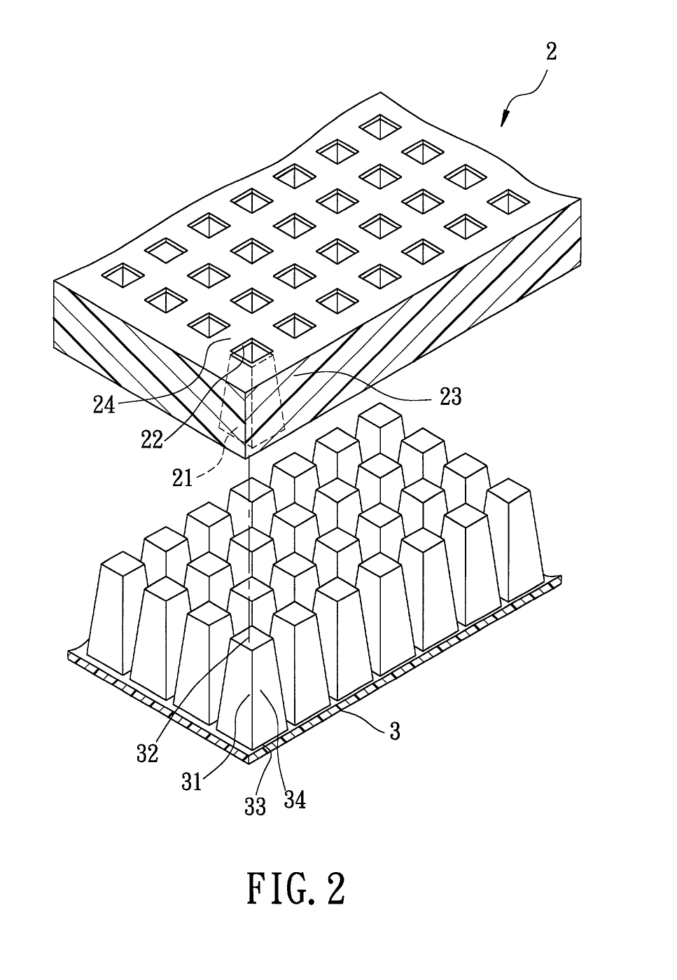

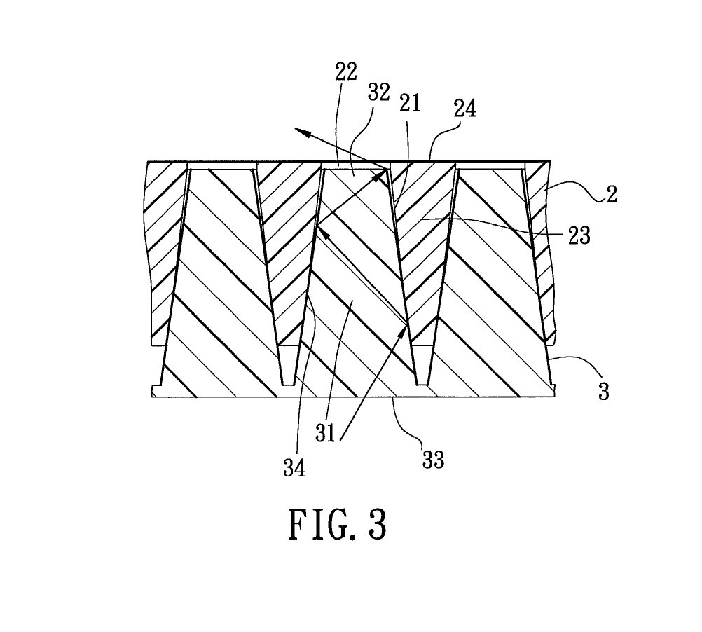

Referring to FIGS. 2 and 3, the first preferred embodiment of a projection screen according to this invention is shown to comprise a lens base 2 and a light-guiding medium 3.

The lens base 2 has a front side, a rear side, and an array of bores 21 that extend from the rear side to the front side. Each of the bores 21 tapers in a direction from the rear side to the front side, and has a square cross-section. The front side of the lens base 2 is formed with a plurality of windows 22, each of which is aligned and communicated with a respective one of the bores 21. Adjacent ones of the bores 21 form an insert post 23 thereamong. The front side of the lens base 2 is further provided with a black coating 24 for absorbing ambient light. In an alternative embodiment, the lens base 2 is made from black light-absorbing material so as to achieve the same effect.

In this embodiment, the light-guiding medium 3 is made of a light-transmitting transparent or semitransparent material having a predetermined refractive index, and includes an array of taper rods 31. Each of the taper rods 31 is inserted into a respective one of the bores 21 from the rear side of the lens base 2. Each of the taper rods 31 has a front end portion 32 and a rear end portion 33, and tapers in a direction from the rear end portion 33 to the front end portion 32. Each of the taper rods 31 has a square cross-section to complement the respective one of the bores 21. Preferably, the rear end portions 33 of the taper rods 31 are interconnected and are disposed outwardly of the respective bores 21. The front end portions 32 of the taper rods 31 do not extend into the windows 22 in the lens base 2. In this embodiment, each of the taper rods 31 has an outer wall surf ace, i.e. the four lateral walls, provided with a metal coating to result in a light-reflective layer 34 at the interface of each taper rod 31 and the respective bore 21. When light is projected from the rear side of the lens base 2, the light enters the light-guiding medium 3 at the rear end portions 33 of the taper rods 31. Due to the light-reflective layer 34 on the outer wall surfaces of the taper rods 31, light is subjected to multiple total internal reflections as it propagates along the taper rods 31. The light exits the taper rods 31 at the front end portions 32 of the latter, and subsequently passes through the windows 22 in the lens base 2 to result in an image that can be viewed from the front side of the lens base 2.

In one alternative embodiment, instead of providing the outer wall surfaces of the taper rods 31 with the metal coating that serves as the light-reflective layer 34, the metal coating can be provided on the inner wall surfaces of the bores 21 to achieve the same result.

In another alternative embodiment, instead of providing either of the outer wall surfaces of the taper rods 31 and the inner wall surfaces of the bores 21 with the metal coating, the light-reflective layer 34 can be formed as a filler layer between each of the taper rods 31 and the respective one of the bores 21. The filler layer has a refractive index smaller than that of the light-transmitting material used to form the light-guiding medium 3, thereby enabling light that propagates along the taper rods 31 to be subjected to multiple total internal reflections. Total internal reflection is a condition in that, when Snell laws of refraction are not satisfied, light that propagates in a medium of high-velocity will be totally reflected at a boundary of the high-velocity medium and a low-velocity medium. In other words, when light in a medium with a higher refractive index reaches a medium with a lower refractive index, if the incident angle is greater than a critical angle, the light will be completely reflected back into the medium with the higher refractive index. For example, in the aforesaid alternative embodiment, air can be present between each of the taper rods 31 and the respective one of the bores 21 to serve as the filler layer. The light-transmitting material for making the light-guiding medium 3 is then selected to have an appropriate refractive index for ensuring total internal reflection at the boundary of the filler layer and the respective taper rod 31.

As to the cross-sections of the bores 21 and the taper rods 31, it should be apparent to those skilled in the art that it is not intended to limit the same to a square. Other shapes, such as a circle, an oval or a rectangle, can be used to achieve substantially the same results.

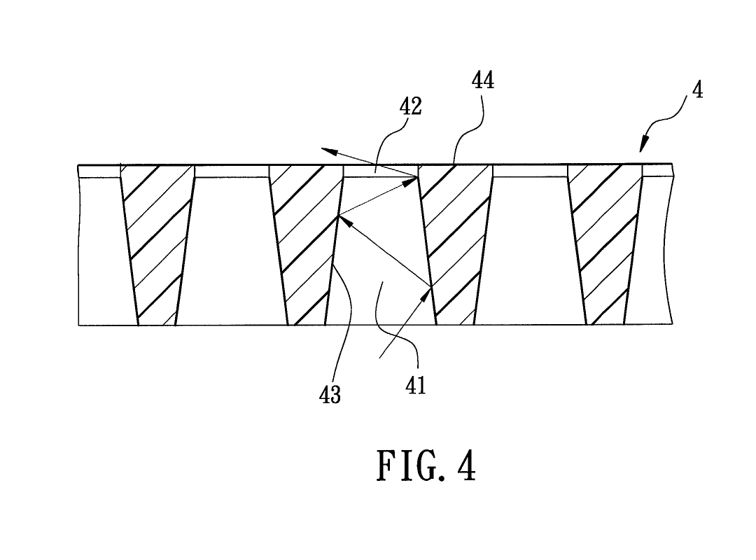

Referring to FIG. 4, the second preferred embodiment of a projection screen according to this invention is shown to comprise a lens base 4 having a front side, a rear side, and an array of bores 41 that extend from the rear side to the front side. Each of the bores 41 tapers in a direction from the rear side to the front side, and has a square cross-section. The front side of the lens base 4 is formed with a plurality of windows 42, each of which is aligned and communicated with a respective one of the bores 41. Each of the bores 41 has an inner wall surface provided with a metal coating that serves as a light-reflective layer 43. Like the previous embodiment, the front side of the lens base 4 is provided with a black coating 44 for absorbing ambient light. Alternatively, the lens base 4 can be made from black light-absorbing material to achieve the same effect.

When light is projected from the rear side of the lens base 4, the light enters the bores 41 and is subjected to multiple total internal reflections as it propagates along the bores 41 due to the presence of the light-reflective layer 43 on the inner wall surface of each of the bores 41. The light exits the lens base 4 through the windows 42 to result in an image that can be viewed from the front side of the lens base 4.

Like the previous embodiment, the cross-section of the bores 41 should not be limited to a square. Other shapes, such as a circle, an oval or a rectangle, can be used to achieve substantially the same results.

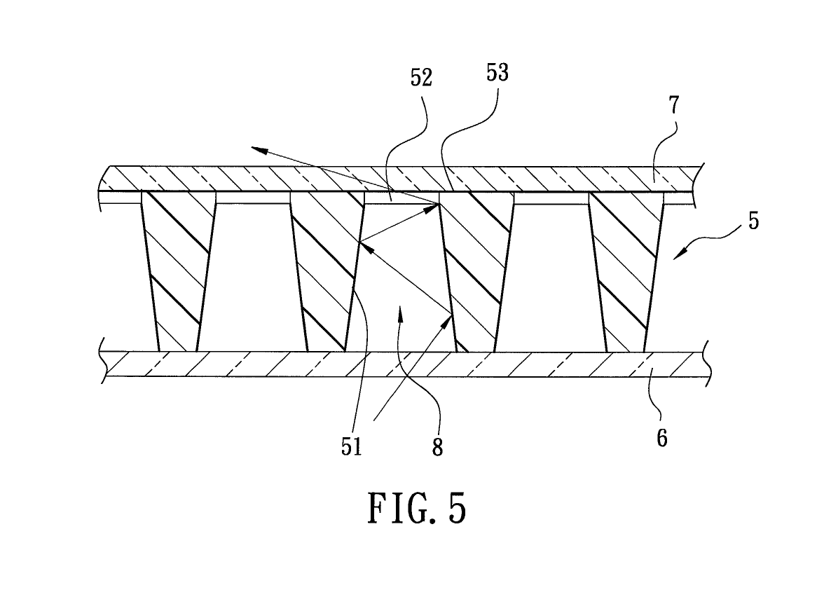

Referring to FIG. 5, the third preferred embodiment of a projection screen according to this invention is shown to comprise a lens base 5, a rear cover plate 6, a front cover plate 7, and a light-guiding medium 8.

The lens base 5 has a front side, a rear side, and an array of bores 51 that extend from the rear side to the front side. Each of the bores 51 tapers in a direction from the rear side to the front side, and has a square cross-section. The front side of the lens base 5 is formed with a plurality of windows 52, each of which is aligned and communicated with a respective one of the bores 51. Like the previous embodiments, the front side of the lens base 5 is provided with a black coating 53 for absorbing ambient light.

Each of the front and rear cover plates 7, 6 is a transparent plate that covers sealingly a respective one of the front and rear sides of the lens base 5, thereby covering front and rear ends of the bores 51.

In this embodiment, the light-guiding medium 8 fills each of the bores 51 and is made of a material with a refractive index larger than that of the material used for making the lens base 5 to allow multiple total internal reflections inside the bores 51. Particularly, when light enters the bores 51 via the rear cover plate 6, the light is subjected to multiple total internal reflections as it propagates along the bores 51. The light exits the lens base 5 through the windows 52 to result in an image that can be viewed from the front cover plate 7.

Like the previous embodiments, the cross-section of the bores 51 should not be limited to a square. Other shapes, such as a circle, an oval or a rectangle, can be used to achieve substantially the same results.

Some of the advantages that can be attributed to the projection screen of this invention are as follows:

1. The output light intensity and the light-viewing angle can be flexibly designed by varying the shape, size and density of the windows in the lens base.

2. Because light is subjected to multiple total internal reflections as it propagates along the bores in the lens base, random phase and random polarization occur to minimize the presence of speckle effect. In addition, because each pixel position of the screen can be configured to include a number of the bores, the occurrence of moire effect can be minimized as well.

3. The sizes of the windows in the lens base can be varied throughout the projection screen, such as by reducing the sizes of the windows from the central portion to the outer periphery of the projection screen, to provide compensation to the cosine θ attenuation of the light intensity distribution, thereby maintaining even brightness of an image throughout the projection screen.

4. Because ambient light can be absorbed at the front side of the lens base, the contrast of the image viewed on the projection screen can be increased.

5. The projection screen of this invention has a relatively simple construction that permits manufacturing of the same at a relatively low cost.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A projection screen, comprising:
a lens base having a front side, a rear side, and an array of bores that extend from said rear side to said front side, each of said bores tapering in a direction from said rear side to said front side, said front side being formed with a plurality of windows, each of which is aligned and communicated with a respective one of said bores; and
reflecting means, disposed in said bores, for subjecting light that enters said bores from said rear side of said lens base to multiple total internal reflections as the light propagates along said bores prior to exiting said lens base at said windows.

2. The projection screen as claimed in claim 1, wherein said front side of said lens base is provided with a black coating for absorbing ambient light.

3. The projection screen as claimed in claim 1, wherein said lens base is made from black light-absorbing material so as to permit absorption of ambient light at said front side of said lens base.

4. The projection screen as claimed in claim 1, wherein said reflecting means comprises an array of taper rods, each of which is made of a light-transmitting material and is inserted into a respective one of said bores from said rear side of said lens base, each of said taper rods having a front end portion and a rear end portion, and tapering in a direction from said rear end portion to said front end portion.

5. The projection screen as claimed in claim 4, wherein said reflecting means further comprises a light-reflective layer provided between each of said taper rods and the respective one of said bores.

6. The projection screen as claimed in claim 5, wherein said light-reflective layer is a metal coating provided on an outer wall surface of each of said taper rods.

7. The projection screen as claimed in claim 5, wherein said light-reflective layer is a metal coating provided on an inner wall surface of each of said bores.

8. The projection screen as claimed in claim 4, wherein said light-transmitting material has a first refractive index, said reflecting means further comprising a filler layer that is provided between each of said taper rods and the respective one of said bores and that has a second refractive index smaller than the first refractive index.

9. The projection screen as claimed in claim 8, wherein said filler layer is air.

10. The projection screen as claimed in claim 1, wherein said reflecting means comprises a metal coating provided on an inner wall surface of each of said bores to serve as a light-reflective layer.

11. The projection screen as claimed in claim 1, further comprising transparent front and rear cover plates that cover sealingly a respective one of said front and rear sides of said lens base to cover front and rear ends of said bores.

12. The projection screen as claimed in claim 11, wherein said lens base is made of a material with a first refractive index, and said reflecting means comprises a light-guiding medium that fills each of said bores and that has a second refractive index larger than the first refractive index.
